(19) United States
(12) Patent Application Publication
(10) Pub. No.: US 2018/0168096 A1
(43) Pub. Date: Jun. 21, 2018

(54) PRODUCT DISTRIBUTION DEVICE COMPRISING A PRESSURE CONTROLLER

(71) Applicant: EXEL INDUSTRIES, Paris (FR)

(72) Inventor: Thibaut DUCAMPS, Paris (FR)

(73) Assignee: EXEL INDUSTRIES, Paris (FR)

(21) Appl. No.: 15/850,289

(22) Filed: Dec. 21, 2017

(30) Foreign Application Priority Data
Dec. 21, 2016 (FR) 16/63013

(51) Int. Cl. A01C 23/00; B05B 13/00; G05D 16/20; G05D 16/18

(52) U.S. Cl. CPC A01C 23/007; B05B 13/005; G05D 16/18; G05D 16/2026; G05D 16/2066

(57) ABSTRACT

A distribution device to distribute a product on a surface, such as agricultural land is provided that includes at least one distribution ramp element and a product distribution circuit. The distribution circuit includes an input port in fluid communication with a product source and a plurality of nozzles fluidly linked in series. The distribution nozzles are disposed along the distribution ramp element and linked to the input port. Each distribution nozzle presents a pressure value. A pressure controller configured to equalize the pressure values of each nozzle is proved to control the pressure of the product along the distribution ramp element. The pressure controller includes a first control member and a second control member, each of the first and second pressure control members being linked in series to the plurality of nozzles and to the input port. The nozzles are disposed between the first and second control members.

### CROSS-REFERENCE TO RELATED APPLICATIONS

This application claims priority to and the benefit of FR 16/63013 filed on Dec. 21, 2016. The disclosure of the above application is incorporated herein by reference.

### FIELD

The present disclosure relates to a distribution device for an agricultural machine, arranged to distribute a product on a surface.

### BACKGROUND

The statements in this section merely provide background information related to the present disclosure and may not constitute prior art.

Generally, distribution devices comprise nozzles spread along a distribution ramp, the product being delivered through a distribution circuit to the nozzles at a predetermined pressure.

Yet, it appears that when the ramp tilts to follow the configuration of the surface, the pressure along the ramp varies. This results in a disparity in the amount of product sprayed along the distribution ramp.

In order to rebalance the output pressure of the nozzles along the ramp, it is known to use a flow rate control system along the ramp, comprising a flow rate controller per nozzle set. Thus, the pressure is controlled per each nozzle set when the ramp tilts.

However, such systems are complex and expensive because of the number of the required flow rate controllers and of the complexity of the control circuit of such a control system. In addition, the flow rate control is carried out in a discrete and not linear manner along the ramp.

### SUMMARY

The present disclosure concerns a distribution device intended to distribute a product on a surface such as an agricultural land, the distribution device comprising:

at least one distribution ramp element; and

a product distribution circuit comprising:

an input port intended to be in fluid communication with a source of the product;

a plurality of nozzles fluidly linked in series, the plurality of nozzles being disposed along the at least one distribution ramp element, the plurality of nozzles being linked in series to the input port, each distribution nozzle among the plurality of distribution nozzles presenting a pressure value; and

a pressure controller configured to equalize the pressure values of each nozzle among the plurality of nozzles for controlling the pressure of the product along the at least one distribution ramp element when this ramp element tilts relative to a horizontal plane.

The pressure controller comprises:

a first control member; and

a second control member,

each of the first and second pressure control members being linked in series to the plurality of nozzles and to the input port, the plurality of nozzles being disposed between the first control member and the second control member.

Thanks to the arrangements according to the present disclosure, only two control members are used to equalize the pressure along a section of the ramp depending on its inclination with respect to a horizontal plane. The implementation of such a device is hence cost-effective. These arrangements also allow equalizing the pressure along the ramp at the inlet of each nozzle of the plurality of nozzles. Thus, the flow rate at the outlet of each nozzle of the plurality of nozzles is equalized so as to be uniform along the ramp.

As used herein, a “ramp element” means a rigid element in a vertical plane, and as illustrated herein.

According to an aspect of the present disclosure, the at least one ramp element is a single-piece.

According to an aspect of the present disclosure, the at least one ramp element is capable of tilting relative to a horizontal plane according to an inclination, in order to adapt to the inclination of the surface of a field.

According to an aspect of the present disclosure, the inclination is comprised between 0 and 30°.

According to an aspect of the present disclosure, the distribution device comprises a product storage tank.

According to an aspect of the present disclosure, the storage tank is fluidly linked to the input port.

According to an aspect of the present disclosure, the distribution device comprises a control sensor configured to measure a physical quantity characteristic of the ramp element or of the distribution circuit.

Thanks to these arrangements, it is possible to know a physical quantity characteristic of the ramp element or of the distribution circuit, along the plurality of nozzles and thus to equalize the pressure along the distribution circuit and thereby to equalize the output flow rate of the plurality of nozzles.

According to an aspect of the present disclosure, the characteristic physical quantity measured by the control sensor is the pressure of the product in the distribution circuit or the inclination of the ramp element.

According to an aspect of the present disclosure, the control sensor comprises at least two pressure sensors disposed on either side of the plurality of nozzles.

Thanks to these arrangements, it is possible to know the pressure on either side of the plurality of nozzles and thus to equalize the pressure along the distribution circuit and therefore to equalize the output flow rate of the plurality of nozzles.

According to an aspect of the present disclosure, the at least one ramp element comprises a first end portion and a second end portion.

According to an aspect of the present disclosure, one of the two pressure sensors is disposed at the first end portion of the at least one distribution ramp element and another of the at least two pressure sensors is disposed at the second end portion.

According to an aspect of the present disclosure, the distribution circuit comprises a return port and a closing member configured to occupy:

a closed position, wherein the closing member closes the return port in order to maintain the pressure within the distribution circuit when the plurality of nozzles distributes the product on the surface; and

an open position, wherein the closing member releases the return port.

Thanks to these dispositions, the pressure within the distribution circuit during the product distribution is maintained and the product distribution is a better spread along the at least one ramp element.

According to an aspect of the present disclosure, the return port is fluidly linked to the storage tank.

When the product distribution on the surface is completed, the distribution device should be cleaned. Clear water is then introduced into the storage tank, and then passes through the distribution circuit so as to clean it before returning back to the storage tank via the return port.

According to an aspect of the present disclosure, the distribution circuit comprises a sprinkler, fluidly linked in series to the nozzles in order to limit the flow rate of the product.

These arrangements allow informing about the value of the pressure drop and controlling the pressure drop.

According to an aspect of the present disclosure, the pressure drop may be natural, due to the natural pressure drops within the distribution circuit, mainly due to the restrictions, the surface defects or the angles, or may be artificial, provided for example by sprinklers that allow controlling the pressure.

According to an aspect of the present disclosure, the distribution device comprises an electronic control unit configured to control the first and second control members.

Thus, the control of the pressure within the distribution circuit is carried out automatically.

According to an aspect of the present disclosure, the electronic control unit is configured to process values of the physical quantity measured by the control sensor and so as to control the first and second control members.

Thus, the control of the pressure within the distribution circuit is carried out automatically thanks to the measurements of the control sensor.

According to an aspect of the present disclosure, each of the first and second control members comprise an electrically or electronically-controlled adjustable automatic valve, arranged to be controlled by the electronic control unit.

According to an aspect of the present disclosure, each of the first and second control members comprise an adjustable valve, and the distribution device comprises an electronic control unit, the electronic control unit being configured to control the adjustable valves.

Thus, it is possible to adjust each adjustable valve in order to obtain an identical fluid pressure at the outlet of each of the adjustable valves.

According to an aspect of the present disclosure, the electronic control unit is configured to control the adjustable valves according to a setpoint.

According to an aspect of the present disclosure, the adjustable valve of each of the first and second control members is for example a ball valve.

According to an aspect of the present disclosure, each of the adjustable valves comprises a first supply path of the plurality of nozzles.

According to an aspect of the present disclosure, each of the adjustable valves comprises a second return path.

According to an aspect of the present disclosure, each of the adjustable valves is electrically linked to the electronic control unit.

According to an aspect of the present disclosure, the electronic control unit is configured to compare the pressure values of the adjustable valves to each other or to a setpoint.

According to an aspect of the present disclosure, the electronic control unit is configured to control each of the adjustable valves in order to equalize the pressure at the outlet of the adjustable valves.

According to an aspect of the present disclosure, the distribution device comprises a supply control element configured to control the product supply to the distribution circuit so as to compensate the speed variations of the agricultural machine.

According to an aspect of the present disclosure, the supply control element is electrical, mechanical, or pneumatic.

According to an aspect of the present disclosure, the supply control element comprises a valve configured to return the excess product within the distribution circuit back to the storage tank.

According to an aspect of the present disclosure, this valve is a three-way valve.

According to an aspect of the present disclosure, the supply control element is configured to adjust the speed of a supply pump of the distribution circuit in order to adjust the flow rate at the input port of the distribution circuit.

According to an aspect of the present disclosure, each of the first and second control members comprises a pneumatically-controlled automatic valve.

Thanks to these arrangements, the control of the pressure within the distribution circuit is carried out automatically and without using electronics, which allows a lightening of the distribution device and decreases the risks related to electrical failures.

According to an aspect of the present disclosure, the pneumatically-controlled automatic valves of the first and second control members are subjected to an identical pressure setpoint.

According to an aspect of the present disclosure, each of the automatic valves comprises two spaces and a flexible membrane arranged to separate the two spaces.

According to an aspect of the present disclosure, a first space among the two spaces is configured to receive air with a predetermined pressure value.

According to an aspect of the present disclosure, a second space among the two spaces is configured to receive the fluid to be distributed.

According to an aspect of the present disclosure, the first spaces of each of the automatic valves are linked by a pneumatic circuit.

According to an aspect of the present disclosure, the movements of the flexible membrane allow adjusting the pressure at each of the automatic valves.

According to an aspect of the present disclosure, the distribution device comprises a primary ramp element and a secondary ramp element, the primary ramp element comprising a primary pressure controller and the secondary ramp element comprising a secondary pressure controller.

Thanks to these arrangements, the ramp elements can carry out the product distribution over a large number of surface configurations. The primary and secondary ramp elements may indeed have different inclinations.

According to an aspect of the present disclosure, the distribution device comprises a primary ramp element and a secondary ramp element, the primary ramp element comprising a primary pressure controller and the secondary ramp element comprising a secondary pressure controller, the second control member of the primary pressure controller and the first control member of the secondary pressure controller being combined.

Thanks to these arrangements, the ramp elements can carry out the product distribution following a V-shaped, an inverted V-shaped or a dissymmetric-shaped configuration.

The present disclosure further relates to an agricultural machine comprising a distribution device in accordance with any one of the above-mentioned characteristics.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 represents an agricultural machine according to the present disclosure;

FIG. 2 represents a distribution circuit disposed along a ramp element according to the present disclosure;

FIG. 3 represents a distribution circuit disposed along two ramp elements according to a first form of the present disclosure; and

FIG. 4 represents a distribution circuit disposed along two ramp elements according to a second form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

FIG. 1 shows an agricultural machine 10 comprising a distribution device 1 according to the present disclosure.

FIG. 2 shows a distribution device 1 intended to distribute a product on a surface such as an agricultural land according to the present disclosure. The distribution device is configured to be installed on an agricultural machine 10. The distribution device 1 comprises a distribution ramp element 2. The ramp element 2 is rigid in a vertical plane. For example, the ramp element 2 can be a single-piece. The ramp element 2 is capable of tilting relative to a horizontal plane of an inclination i, in order to adapt to the inclination of the surface. The inclination i is for example comprised between 0 and 30°.

The distribution device 1 further comprises a product distribution circuit 5.

The distribution circuit 5 comprises an input port 7 intended to be in fluid communication with a source of the product. Indeed, the distribution device 1 comprises a product storage tank (not represented). The storage tank is fluidly linked to the input port 7.

The distribution circuit 5 comprises a plurality of nozzles 11 fluidly linked in series. The plurality of nozzles 11 is disposed along the ramp element 2. The plurality of nozzles 11 is linked to the input port 7 in series. Each distribution nozzle among the plurality of nozzles 11 has a pressure value.

The distribution circuit 5 further comprises a pressure regulator 13 configured to equalize the pressure values of each nozzle among the plurality of nozzles 11 in order to control the pressure of the product along the ramp element 2 when this ramp element tilts relative to a horizontal plane.

The pressure controller 13 comprises a first control member 13a and a second control member 13b. each of the first and second control members 13a, 13b, is linked in series to the plurality of nozzles 11 and to the input port 7. The plurality of nozzles 11 is disposed between the first control member 13a and the second control member 13b.

The distribution circuit 5 comprises a control sensor 14 comprising two pressure sensors 15a, 15b disposed at the end portions of the ramp element 2, that is to say on either side of the plurality of nozzles 11 disposed along the ramp element 2. Thus, it is possible to know the pressure at the ends of the ramp and therefore to equalize the pressure along the distribution circuit 5 and therefore to equalize the output flow rate of the plurality of nozzles 11, when the ramp element 2 tilts.

According to another form, the control sensor 14 comprises an inclinometer, arranged to measure the inclination of the ramp element 2.

Each of the first and second control members 13a, 13b comprises an adjustable valve 23a, 23b. The adjustable valve 23a, 23b of each of the first and second control members 13a, 13b is for example a ball valve. The distribution device 1 comprises an electronic control unit, the electronic control unit being configured to control the adjustable valves 23a, 23b. The electronic control unit is then electronically linked to the pressure sensors 15a, 15b and to the adjustable valves 23a, 23b. The electronic control unit is configured to control the adjustable valves 23a, 23b in order to equalize the pressure values at the outlet of the plurality of nozzles 11. Indeed, the pressure sensors 15a, 15b, communicate the pressure values recorded periodically or continuously to the electronic control unit. The electronic control unit compares the pressure values. If the pressure values of each of the pressure sensors 15a, 15b are identical, the electronic control unit does not send any command to the adjustable valves 23a, 23b. If the pressure values of each of the pressure sensors 15a, 15b are different, the electronic control unit sends a command to the lowest adjustable valve with respect to the vertical in order to modify its opening, allowing to equalize the pressures at the outlet of the adjustable valves. It is thus possible to adjust the opening of each adjustable valve 23a, 23b in order to obtain an identical fluid pressure at the outlet of each of the adjustable valves 23a, 23b and therefore an identical flow rate at the outlet of the plurality of nozzles 11.

The pressure controller may further comprise a user interface. The user interface is electronically linked to the electronic control unit. The user interface allows the user to follow the evolution of the pressure values at the pressure sensors 15a, 15b.

According to another form, the electronic control unit may also control the adjustable valves according to a pressure setpoint. This form differs from the previous form in that the user enters a setpoint in the user interface. When the agricultural machine distributes the product on the surface, the electronic control unit controls the adjustable valves 23a, 23b so that the pressure values at the pressure sensors 15a, 15b are identical to the setpoint.

Each of the adjustable valves 23a, 23b comprise a first supply path of the nozzles. Each of the adjustable valves 23a, 23b may comprise a second return path.

The distribution device 1 may further comprise a supply control element configured to control the product supply to the distribution circuit 5 so as to compensate the speed variations of the agricultural machine 10. The supply control element may be electrical, mechanical or pneumatic. The supply control element may for example comprise a pump. The supply control element may also comprise a three-way valve configured to return the excess product within the distribution circuit 5 back to the storage tank. The supply control element is configured to adjust the speed of a feed pump of the distribution circuit 5 in order to adjust the flow rate at the input port 7 of the distribution circuit 5.

According to another form, each of the first and second control members 13a, 13b comprise a pneumatically-controlled automatic valve 25a, 25b. This form differs from the previous forms in that each of the automatic valves 25a, 25b comprise two spaces and a flexible membrane arranged to separate the two spaces. A first space among the two spaces is configured to receive air with a predetermined pressure value. A second space among the two spaces is configured to receive the fluid to be distributed. Thus, thanks to the flexible membrane, the pressure in the first space influences the pressure in the second space, thus allowing to control the product pressure along the distribution circuit 5.

The first spaces of each of the automatic valves are linked by a pneumatic circuit. The pneumatic circuit has a pressure value subjected to a setpoint. The setpoint can be defined either manually by the user via the user interface or by a control box. Indeed, the setpoint can be automatically calculated by the control box depending on the pressure values read by the pressure sensors 15a, 15b, on instantaneous flow rate values measured by other sensors, on the speed of the agricultural machine and/or any other information serving to control the flow rate. The flexible membrane then allows adjusting the pressure at each of the automatic valves. Indeed, the movements of one of the flexible membranes is perceived by the other flexible membrane via the pneumatic circuit. The pneumatic circuit having the same pressure in every point, the equalization of the pressures in the pneumatic circuit is carried out automatically. By compensation, the pressure in the distribution circuit 5 is also automatically equalized. Thus, an electronic control unit and the electronic connections are not necessary. As a result, the distribution device is less expensive and less prone to electronic malfunctions.

The control box can also control the supply control element.

The distribution circuit 5 comprises a return port 17 and a closing member 19. The closing member can occupy a closed position and an open position. In the closed position, the closing member 19 closes the return port 17 in order to maintain the pressure in the distribution circuit 5 when the plurality of nozzles 11 distributes the product on the surface. In the open position, the closing member 19 releases the return port 17 so as to allow for example the cleaning of the distribution circuit 5. Hence, the pressure in the distribution circuit 5 during the product distribution is maintained and the product distribution is better spread along the ramp element 2.

The return port 17 is fluidly linked to the storage tank. When the product distribution on the surface is completed, the distribution device 1 should be cleaned. Clear water is then introduced into the storage tank, and then passes through the distribution circuit 5 before returning back to the storage tank via the return port 17.

The distribution circuit 5 comprises a sprinkler 21 fluidly linked in series to the plurality of nozzles 11 in order to limit the flow rate of the product. For example, a sprinkler can be disposed between each nozzle or group of nozzles. Thus, it is possible to know the value of the pressure drop or to increase the pressure drop artificially. The artificial sprinkler 21 can be placed in the distribution circuit 5 in addition to the natural pressure drops, in case a high compensation is to be obtained.

Another form is shown in FIG. 3. This form differs from the previous forms in that the distribution device 1 comprises a primary ramp element 31 and a secondary ramp element 33. The primary ramp element 31 comprises a primary pressure controller 35 and the secondary ramp element 33 comprises a secondary pressure controller 37. Thus, the primary and secondary ramp elements 31, 33 can carry out the product distribution over a large number of surface configuration. The primary and secondary ramp elements 31, 33, can indeed present different inclinations.

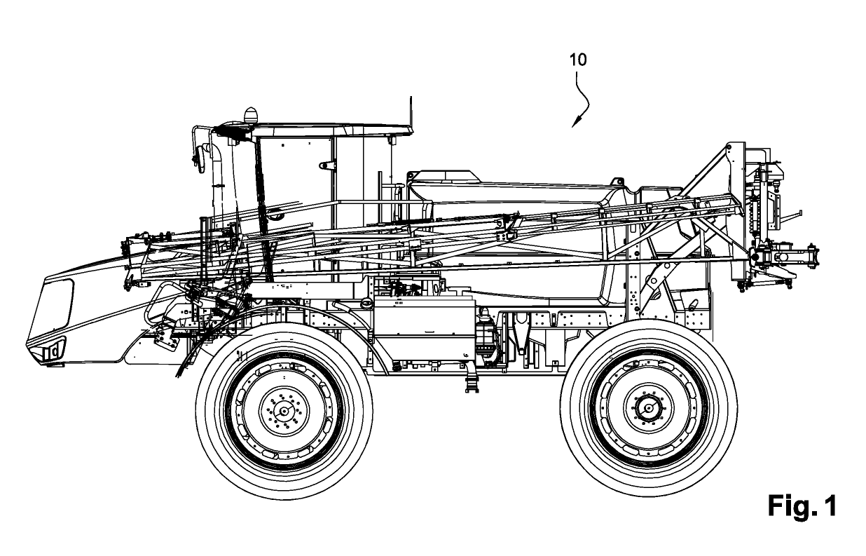

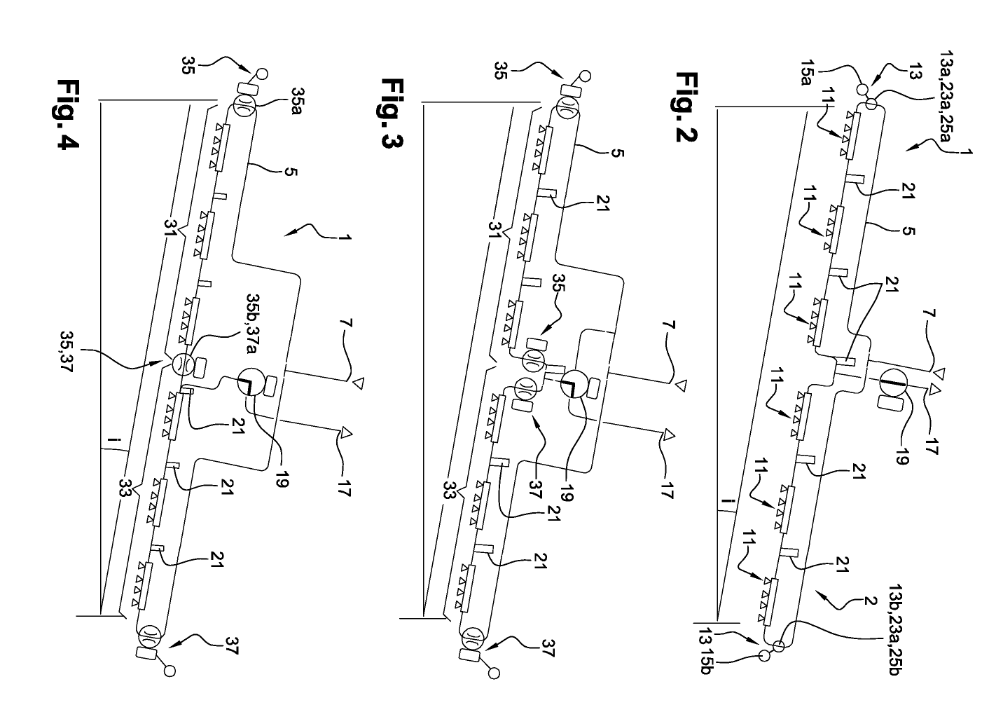

Another form is shown in FIG. 4. The distribution device also comprises a primary ramp element 31 and a secondary ramp element 33. The primary ramp element 31 comprises a primary pressure controller 35 comprising a first control member 35a and a second control member 35b. The secondary ramp element 33 comprising a secondary pressure controller 37 comprising a first control member 37a and a second control member 37b. This form differs from the previous forms in that the second control member 35b of the primary pressure controller 35 and the first control member 37a of the secondary pressure controller 37 being combined. Thus, the primary and secondary ramp elements 35, 37 can carry out the product distribution following a V-shaped or an inverted V-shaped configuration. These arrangements allow adapting to symmetrical surface configurations and saving a control member.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A distribution device configured to distribute a product on a surface such as an agricultural land, the distribution device comprising:
at least one distribution ramp element; and
a product distribution circuit comprising:
an input port in fluid communication with a source of the product;
a plurality of distribution nozzles fluidly linked in series, the plurality of distribution nozzles being disposed along the at least one distribution ramp element, the plurality of distribution nozzles being linked to the input port in series, each distribution nozzle of the plurality of distribution nozzles having a pressure value; and
at least one pressure controller configured to equalize the pressure values of each distribution nozzle among the plurality of distribution nozzles in order to control the pressure of the product along the at least one distribution ramp element when the at least one distribution ramp element tilts relative to a horizontal plane, each pressure controller comprising:
a first control member; and
a second control member,
wherein each of the first and second control members are linked in series to the plurality of distribution nozzles and to the input port of the product distribution circuit, and
wherein the plurality of distribution nozzles are disposed between the first control member and the second control member.

2. The distribution device according to claim 1 further comprising a control sensor on either side of the plurality of distribution nozzles, the control sensor configured to measure a physical quantity characteristic of the at least one distribution ramp element or the product distribution circuit.

3. The distribution device according to claim 2, wherein the physical quantity characteristic measured by the control sensor is at least one of the pressure of the product in the product distribution circuit and the inclination of the at least one distribution ramp element.

4. The distribution device according to claim 1 further comprising a return port and a closing member configured to occupy a closed position, wherein the closing member closes the return port in order to maintain pressure in the product distribution circuit when the plurality of distribution nozzles distributes the product on the surface, and an open position, wherein the closing member releases the return port.

5. The distribution device according to claim 1 further comprising a supply control element configured to control product supply to the product distribution circuit so as to compensate for speed variations of the agricultural machine.

6. The distribution device according to claim 1 further comprising at least one sprinkler fluidly linked in series to the plurality of distribution nozzles in order to control a flow rate of the product.

7. The distribution device according to claim 1 further comprising an electronic control unit configured to control the first and second control members of the pressure controller.

8. The distribution device according to claim 7, wherein the electronic control unit is configured to process values of a physical quantity measured by a control sensor in order to control the first and second control members.

9. The distribution device according to claim 8, wherein each of the first and second control members comprise an electrically or electronically-controlled adjustable automatic valve arranged to be controlled by the electronic control unit.

10. The distribution device according to claim 1, wherein each of the first and second control members comprise a pneumatically-controlled automatic valve.

11. The distribution device according to claim 10, wherein the pneumatically-controlled automatic valves of the first and second control members are subjected to an identical pressure setpoint.

12. The distribution device according to claim 1, further comprising a primary ramp element and a secondary ramp element, the primary ramp element comprising a primary pressure controller and the secondary ramp element comprising a secondary pressure controller.

13. The distribution device according to claim 1 further comprising a primary ramp element and a secondary ramp element, the primary ramp element comprising a primary pressure controller and the secondary ramp element comprising a secondary pressure controller, the second control member of the primary pressure controller and the first control member of the secondary pressure controller being combined.

14. The agricultural machine comprising the distribution device according to claim 1.
